(19) United States
(12) Patent Application Publication
(10) Pub. No.: US 2025/0238682 A1
(43) Pub. Date: Jul. 24, 2025

(54) MULTI-EDGE COOPERATIVE UNIVERSAL FRAMEWORK FOR LOAD PREDICTION WITH PERSONALIZED FEDERATED DEEP LEARNING

(71) Applicant: FUZHOU UNIVERSITY, Fuzhou (CN)

(72) Inventors: Zheyi CHEN, Fuzhou (CN); Lixian CHEN, Fuzhou (CN); Luying ZHONG, Fuzhou (CN); Longxiang XUE, Fuzhou (CN); Qingnan JIANG, Fuzhou (CN)

(73) Assignee: FUZHOU UNIVERSITY, Fuzhou (CN)

(21) Appl. No.: 18/585,110

(22) Filed: Feb. 23, 2024

(30) Foreign Application Priority Data
Jan. 23, 2024 (NL) 2036871

(51) Int. Cl. G06N 3/098

(52) U.S. Cl. CPC G06N 3/098

(57) ABSTRACT

A Multi-edge Cooperative Universal Framework for Load Prediction with Personalized Federated Deep Learning adopts an FDL-based cooperative training manner in multi-edge environments, and uses site IDs of edge servers as the basis for dividing the regions of cooperative training. The edge servers within the same site are regarded as clients in FDL, and they conduct cooperative training with the cloud server (i.e., the parameter server in FDL), customize personalized models for each edge by independent control parameters and theoretically analyze the model convergence improvement.

### CROSS REFERENCE TO RELATED APPLICATIONS

This application is based upon and claims foreign priority to Netherlands Patent Application No. N2036871, filed on Jan. 23, 2024, the entire contents of which are incorporated herein by reference.

### TECHNICAL FIELD

The present invention belongs to the technical field of load prediction, multi-edge cooperation, sequential data analysis, personalized federated learning, recurrent neural networks, in particular relates to A Multi-edge Cooperative Universal Framework for Load Prediction with Personalized Federated Deep Learning.

### BACKGROUND

As an emerging computing paradigm in the Internet-of-Things (IoT) era, edge computing can help improve the Quality-of-Service (QoS) of IoT applications (e.g., autonomous driving, AR/VR, and smart cities) through deploying computing and storage resources at the network edge closer to end devices. By 2025, the total number of IoT devices worldwide will reach 30.9 billion. If the running data and computing tasks of all IoT applications are uploaded from end devices to the remote cloud, it will undoubtedly consume massive bandwidth resources and bring considerable processing burdens to cloud data centers. Meanwhile, the long-distance data transmission between end devices and the remote cloud will cause serious response delays of IoT applications. Compared to classic cloud computing, edge computing can significantly reduce the delays of data transmission and task processing, lessen system costs, and enhance the QoS to a certain extent.

Therefore, the emergence of edge computing can effectively support high performance demands of numerous IoT applications.

Load prediction, as an important technique in edge computing, can support edge systems conducting up-front and rational resource provisioning, thus enhancing the QoS and saving resource overheads. For example, when a large number of service requests simultaneously reach edge systems, insufficient resource provisioning will increase the response time of IoT applications. In contrast, if there is only a small number of service requests arrive at edge systems over a long time, over-provisioning of resources will cause frequent occurrences of idle system status and massive resource wastes. Through predicting the changes of future edge loads and accordingly adjusting resource provisioning, not only can the service level agreement (SLA) be better guaranteed but also the running efficiency of edge systems be improved. For instance, edge systems can utilize the results of load prediction to guide the allocation and migration of virtual machines in advance, alleviating problems of server overload and network congestion. Moreover, through load prediction and up-front resource provisioning, both the resource utilization and overheads of edge systems can be greatly improved.

Most of the existing studies on load prediction target cloud environments, and usually adopt regression-based methods, heuristics, or classic neural networks (NNs). Compared to regression-based methods and heuristics, classic NNs can achieve more accurate prediction for the loads with apparent changing trends. However, classic NNs only contain shallow network structures such as multi-layer perceptron (MLP) and radial basis function (RBF), and thus they may not achieve high prediction accuracy when facing highly-variable edge loads because they cannot effectively capture the patterns of load variations.

To relieve this problem, recurrent neural networks (RNNs) have been designed and applied to load prediction, revealing good performance in modeling and processing of timeseries data. However, due to the issue of gradient vanishing or explosion, it is difficult for classic RNN to learn longterm memory dependencies. To address this issue, some improved variants of RNN have been developed such as long short-term memory (LSTM) and gated recurrent unit (GRU), which exhibit excellent learning ability for long-term memory. Moreover, due to the high noise interference in raw load data, non-linear models commonly suffer from the over-fitting problem and difficulty in generalization, which seriously affects prediction accuracy. Besides, compared to cloud data centers, edge servers are more discretely distributed with smaller deployment scales, and thus they may not own sufficient historical load data. The challenges of edge load prediction are summarized as follows.
High variability and noise of loads. Edge environments are dynamically changing due to diverse user requests and elastic resource provisioning, and thus the loads on different edge servers are usually highly variable and unevenly distributed over time. For example, the maximum load disparity of cross-site edge servers is 19.8 times, while this metric for same-site edge servers also reaches 14.3 times. Moreover, complex edge environments introduce massive noise to load data. Such high variability and noise cause great difficulty in achieving accurate and efficient load prediction.
Insufficient historical load data. Deep learning (DL) based load prediction models commonly require a large amount of historical load data for training, in order to guarantee high accuracy. However, unlike cloud data centers, there is only a small amount of historical load data stored in an edge server, making it difficult to train prediction models with high accuracy if the training is independently conducted by a single edge server.
Limited generalization ability of models. Loads of different edge servers are continuously and dynamically changing along with their deployment environments and application scenarios, which leads to huge differences in load distribution among different edge servers. When facing such highly-diverse distribution of load data samples, the prediction model trained by a single edge server reveals limited generalization ability and cannot well adapt to dynamic edge environments.

### RNN-Based Time-Series Prediction

The output of classic feedforward neural networks (NNs) is only related to the input at the current moment. However, the data is often correlated in time series when dealing with some real-world problems such as load and traffic prediction. Therefore, the status of NNs at a certain moment is not only related to the current input but also may be affected by the output at some previous moments. Unfortunately, classic feedforward NNs cannot well handle such time-series correlation. As an emerging deep learning (DL) model, RNN has been widely applied to deal with timeseries prediction. Different from classic feedforward NNs, RNNs are able to memorize and capture temporal dependencies when processing sequential data, which introduces the design of recurrent connections based on feedforward NNs. Therefore, the output of NNs depends on both the current input and the previous status information. In RNN, the input of each moment is combined with the output of the previous moment to generate the status of NNs at the current moment, and the status is then passed to the next moment. Such recurrent structure allows RNN to save information in sequences and use it for future prediction. However, classical RNN suffers from the problem of gradient vanishing or explosion when facing long sequences, making it difficult to learn long-term dependencies. To relieve this problem, some improved RNN variants have been designed such as long short-term memory (LSTM) and gated recurrent unit (GRU).

With proper data preprocessing and training, RNN-based models can effectively capture temporal dependencies in sequences and utilize past observations to predict future changes. Based on historical memory and current input, the future output can be predicted as

$${s}_{t} = tanh ( U \cdot {x}_{t} + W \cdot {s}_{t - 1} ) , {y}_{t} = soft max ( V \cdot {s}_{t} ) , \qquad ( 1 )$$

where sₜ, xₜ, and yₜ indicate the hidden status, input, and output at the moment t, respectively.

### Federated Learning

In classic FL, different clients use their own local data for local model training, aiming to cooperatively learn a global model w and minimize its average loss across all clients. This process is commonly defined as

$${min}_{w ∈ {ℝ}^{d}} {F}_{avg} = {\sum }_{k = 1}^{K} \frac{{n}_{k}}{n} {ℓ}_{k} ( w ) , \qquad ( 2 )$$

where K is the number of clients, nₖ indicates the data amount on the client k, n indicates the total data amount of all clients (i.e., Σₖ nₖ=n), and lₖ indicates the loss on the client k.

Different from the centralized training mode, the training data is distributed across different clients in FL. Multiple clients cooperatively train a global model by continuously uploading and updating the parameters of their local models without assembling their local data during the process. However, in real-world scenarios, the local data on different clients may be seriously affected by generation ways and user behaviors, leading to significant discrepancies in data distribution among different clients. This phenomenon triggers the emergence of the client-drift issue, which causes the degraded convergence speed and generalization of model training in FL.

In recent years, both load prediction, FL, and edge computing have attracted much research attention, and many scholars have contributed to these important areas. This section reviews and analyzes classic methods for load prediction and the application of FL in edge computing:

### Classic Methods for Load Prediction

Most of the existing studies on load prediction commonly target cloud environments.

In general, regression-based methods can achieve accurate prediction when facing loads with clear patterns or trends. However, it is difficult for them to capture and utilize essential load characterizations when loads are highly variable in edge environments. To better deal with this problem, some studies adopted advanced RNN-based methods for load prediction. To support high prediction accuracy, RNN-based methods commonly rely on a large amount of historical load data offered by cloud data centers for model training. In recent years, emerging edge computing has attracted extensive attention from both academia and industry, which constructs a distributed and flexible architecture that is different from classic cloud computing. As a key technical support in edge computing, load prediction can be used to better support up-front and rational provisioning of edge resources. However, edge load patterns are more complex and changeable compared to cloud environments. Meanwhile, the historical load data in a single edge server is limited and load distributions among different edge servers vary greatly. Therefore, it is extremely challenging to obtain a load prediction model with high accuracy and strong generalization ability through independent training on a single edge server.

### FL in Edge Computing

As an emerging distributed machine learning framework, FL provides a feasible solution for data processing and model training in edge environments.

Generally, FL exhibits a promising application prospect in edge computing. FL can make full use of the data distributed across clients, which solves the problem of insufficient training data on a single client and meanwhile protects data privacy. Most of the existing studies focus on the application of FL between edge and end-device layers. With the development of cloud-edge cooperation mode, some studies have begun considering the combination of FL and cloudedge cooperation. In classic FL, the data of different clients is not identically and independently distributed, and thus the global model may not perform well on some clients. In edge environments, the load conditions of different edge servers are continuously and dynamically changed due to their various deployment and application scenarios, causing huge distinctions in the distribution of load data among different edge servers. However, classic FL reveals the limitation of generalization ability and cannot well handle this problem. Considering the impacts of both global and local models on the FL training process, personalized FL can serve as a potentially viable solution to improve model performance and generalization ability. However, it still needs to further explore and research the application of personalized FL in edge load prediction.

### SUMMARY

The purpose of the present invention is to provide a Multi-edge Cooperative Universal Framework for Load Prediction with Personalized Federated Deep Learning.

The emerging load prediction techniques support up-front and rational resource provisioning in edge systems to enhance system efficiency and Quality-of-Service (QoS). Classic prediction methods may handle loads with apparent trends, but they cannot achieve accurate prediction for highly-variable edge loads. With the advantage of sequential data analysis, recurrent neural networks (RNNs) are often used for load prediction but reveals limited generalization ability and low training efficiency. Moreover, it is hard to obtain a well-performed prediction model by discrete single-edge training with insufficient historical data. To address these important challenges, we propose a novel Multi-edge Cooperative universal framework for load Prediction with Personalized Federated deep learning (MC-2PF), enabling multi-edge cooperative training of load prediction models. Specifically, to solve the client-drift issue in federated learning (FL) caused by distinct data distribution, we customize personalized models for each edge by independent control parameters and theoretically analyze the model convergence improvement. Meanwhile, we exhibit the universality of applying the MC-2PF to RNN-based prediction models through a practical example. Using the real-world testbed and load datasets, extensive experiments verify the effectiveness and practicality of the MC-2PF for different RNN-based prediction models. Compared to benchmark frameworks, the MC-2PF achieves higher prediction accuracy, faster convergence, and stronger adaptiveness.

To realize the above purpose, the technical solution of the present invention is as follows:

A Multi-edge Cooperative Universal Framework for Load Prediction with Personalized Federated Deep Learning:
adopts an FDL-based cooperative training manner in multi-edge environments, use site IDs of edge servers as the basis for dividing the regions of cooperative training; The edge servers within the same site are regarded as clients in FDL, and they conduct cooperative training with the cloud server (i.e., the parameter server in FDL).

Furthermore, The FDL cooperative training comprises the following steps:
Step 1: The parameter server selects FDL clients to participate in the current round of federated aggregation;
Step 2: The selected FDL clients participate in the current round of federated aggregation;
Step 3: The FDL clients receive the global model and control parameters distributed by the parameter server and then starts local training with historical loads;
Step 4: Each FDL client preprocesses the historical load data stored on its edge server including cleaning, resampling, normalization, feature extraction, and denoising;
Step 5: Guided by the global model, global control parameters, and local control parameters, each FDL client trains and updates its local load prediction model through multiple epochs of training, validation, and testing;
After all selected FDL clients complete their local training and upload their local models and control parameters, the parameter server will make aggregation;
The parameter server updates the global model and control parameters and then starts the next round of FDL cooperative training.

Furthermore, The well-trained model is used to predict future edge loads.

Furthermore, First, the parameter server initializes the global model w, global control parameters c, and number of clients K; Each FDL client maintains its local control parameters cₖ, and both c and cₖ are initialized by 0, where

$$c = \frac{1}{K} {\sum }_{k = 1}^{K} {c}_{k}$$

should be guaranteed; For each FDL communication round, according to the selection ratio C, the parameter server randomly selects max (C·K, 1) FDL clients from all K FDL clients to participate in the federated aggregation, and the FDL client set S is built, where the function max (,) is used to avoid training interruptions if no FDL client is selected; Next, the parameter server distributes the global model w and global control parameters c to each FDL client in S;

For each FDL client k (k∈S), it will receive the global model and global control parameters (w, c) and update its local model and local control parameters (wₖ, cₖ); Specifically, each FDL client conducts model training by utilizing local load data, which contains the runtime information of resource usage on edge servers.

Furthermore, Use CPU usage as the main prediction metric; For an edge server, xₜ indicates the CPU usage at t, and the time-series sequence of loads is denoted as X={x₁, x₂, . . . xₙ}.

Furthermore, For the invalid load data, replace it by taking the interval average during the preprocessing process and meanwhile compress it by resampling, which can extract the important features of raw load data; and thus normalize raw loads, aiming to speed up the convergence of local models; After normalization, the raw load data is mapped to the range [0,1], and this process is defined as

$$\tilde{X} = \frac{X - {X}_{min}}{{X}_{max} - {X}_{min}}$$

where X indicates the raw load data; Xₘₐₓ and Xₘᵢₙ are the maximum and minimum CPU usage in the raw load data, respectively.

Furthermore, Use a Savitzky-Golay (SG) based filter to smooth the raw load data, aiming to minimize the interference of noise; Specially, define a sub-sequence of X̅ as

$${S}_{q} = \{ {\tilde{x}}_{q - w} , {\tilde{x}}_{q - w + 1} , … , {\tilde{x}}_{q} , … {\tilde{x}}_{q + w - 1} , {\tilde{x}}_{q + w} \}$$

where S_{q}⊆\tilde{X}, q is the center point of S_{q}, w is half the window length, and the length of S_{q} is (2w+1);

Next, perform fitting for each element in S_{q} by

$${x}_{q + k}^{′} = {\sum }_{i = 0}^{γ} {a}_{i} {\tilde{x}}_{q + k}^{i}$$

where \tilde{x} and x′ are the elements before and after fitting, respectively; Moreover, a is the fitting parameter and γ is the polynomial number;

Realize the element fitting in the window by solving a system of γ-element linear equations; Specifically, we first build a system of γ-element linear equations by forming (2w+1) equations from the elements in S_{q}; Next, the least square method is used to determine the fitting parameter a; The proposed SG-based filter will work in a sliding-window way until all load data is preprocessed.

Furthermore, Split the preprocessed load data X′ into batches to serve as local training data for FDL clients; Each FDL client performs E epochs for training its local model, and the process of the local model update is defined as

$${w}_{k} ← {w}_{k} - η ( ∇ {ℓ}_{k} ( {w}_{k} : b ) - {c}_{w} + c )$$

where we introduce the difference term (c_{w}−c) to estimate the client-drift degree and use this term to correct the update direction of local models in time;

After completing local training, the local control parameters are updated and this process is defined as

$${c}_{k} ← {c}_{k} - c + \frac{1}{E η} ( w - {w}_{k} )$$

where η is the learning rate; The update of local control parameters cₖ considers the global control parameters c and the difference between the global model and the updated local model, denoted by (w−wₖ);

Finally, the FDL client k uploads the updated wₖ and cₖ to the parameter server; After receiving the updated parameters of all participated clients, the parameter server updates the global model w and global control parameters c and then starts the next round of FDL training; The update process is defined as

$$w ← {\sum }_{k = 1}^{K} \frac{{n}_{k}}{n} {w}_{k} ,$$

$$c ← {\sum }_{k = 1}^{K} \frac{{n}_{k}}{n} {c}_{k} .$$

Compared with the prior art, the present invention has the following beneficial effects:
1. To the best of our knowledge, this work is the first of its kind to propose a universal framework for load prediction, which innovatively integrates multi-edge cooperation with personalized federated deep learning (FDL). The proposed MC-2PF framework is able to adaptively achieve accurate and efficient prediction of edge loads by solving the key challenges including high variability and noise of loads, insufficient historical load data, and limited generalization ability of models.
2. We design novel model control parameters for the cloud and edge servers, which support the construction of personalized prediction models for various environments. The model control parameters are able to estimate and correct the update directions of local and global models, overcoming the client-drift issue in classic FL that is caused by highly-distinct data distribution. Moreover, we develop a Savitzky-Golay (SG) based filter to smooth raw load data, which can reduce noise interference and mitigate model over-fitting.
3. We theoretically analyze the convergence improvement by using the proposed model control parameters, which are proven to guide the right learning direction of load prediction models on different edge scenarios during the training process of FDL. Furthermore, we present the application workflow of the MC-2PF for RNN-based prediction models through a real-world case study, verifying its practicality and universality.
4. Using the real-world testbed and datasets of edge loads, extensive experiments are conducted to validate the effectiveness of the proposed MC-2PF. The results show that the MC-2PF can be applied to train advanced RNN-based models and achieve accurate and efficient prediction. The MC-2PF shows stronger adaptiveness and achieves higher prediction accuracy than the singleedge training framework on various RNN-based models. Compared to the benchmark FL framework, the MC-2PF is able to further improve the prediction accuracy and convergence speed under different scenarios with various prediction lengths.

### BRIEF DESCRIPTION OF THE DRAWINGS

FIG. 1 shows overview of the proposed MC-2PF.

FIG. 2 shows improvement of model convergence by control parameters.

FIG. 3 shows structure of the LSTM cell.

FIG. 4 shows high variation of load patterns over different edge servers.

FIG. 5 shows comparison of load data before and after resampling.

FIG. 6A-C shows comparison of load data before and after using the SG-based filter.

FIG. 7A-C shows prediction accuracy under different scenarios by using the SG-based filter with various settings.

FIG. 8A-D shows model Convergence on different edge servers with the proposed MC-2PF and classic FedAvg.

FIG. 9A-C shows comparison of the communication rounds for convergence by using the LSTM and S2S-GRU under the proposed MC-2PF and FedAvg.

FIG. 10A-C shows performance of the S2S-GRU with the MC-2PF under different prediction scenarios.

FIG. 11A-D shows performance of the S2S-GRU with the MC-2PF for different types of loads under the minute-prediction scenario.

### DETAILED DESCRIPTION OF THE EMBODIMENTS

The technical solution of the present invention is described in detail in combination with the accompany drawings.

Based on the RNN-based time-series prediction and federated learning (FL), we conduct accurate and efficient prediction for edge loads by solving three important challenges including high variability and noise of loads, insufficient historical load data, and limited generalization ability of models.

### Overview of MC-2PF and Problem Formulation

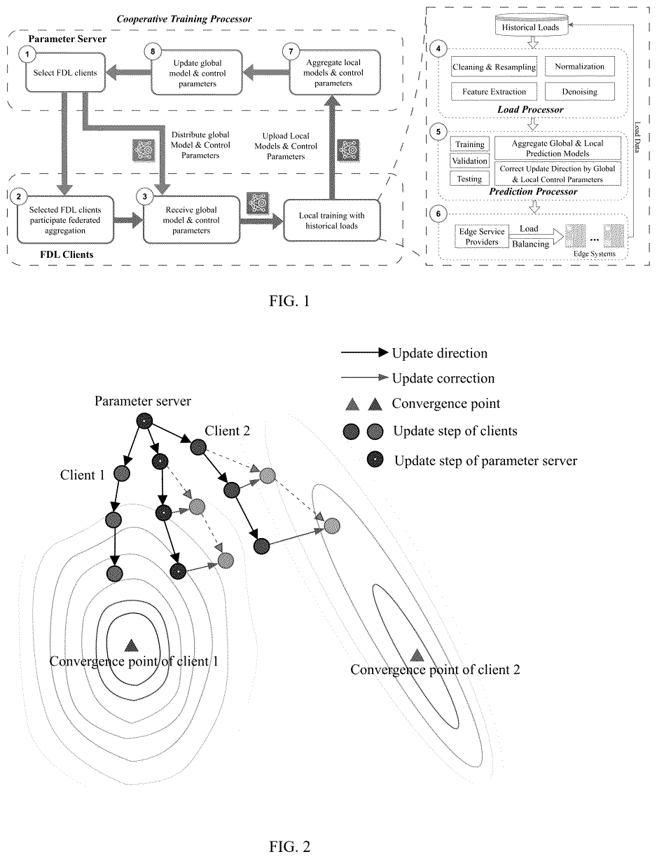

FIG. 1 overviews of the proposed MC-2PF. To better meet service demands and save resource overheads, edge systems should be able to make efficient resource provisioning according to current and future load variations. However, due to the high variability of edge loads, it is difficult to quickly draw up ideal resource provisioning schemes, which seriously affects the QoS. Meanwhile, unreasonable resource provisioning also leads to excessive operation and maintenance costs or SLA violations. Different from the centralized load prediction in cloud computing, the proposed MC-2PF adopts an FDL-based cooperative training manner in multi-edge environments. Specifically, we use site IDs of edge servers as the basis for dividing the regions of cooperative training. The edge servers within the same site are regarded as clients in FDL, and they will conduct cooperative training with the cloud server (i.e., the parameter server in FDL). Specifically, the main steps of the MC-2PF are given as follows.
Step 1: The parameter server selects FDL clients to participate in the current round of federated aggregation.
Step 2: The selected FDL clients participate in the current round of federated aggregation.
Step 3: The FDL clients receive the global model and control parameters distributed by the parameter server and then starts local training with historical loads.
Step 4: Each FDL client preprocesses the historical load data stored on its edge server including cleaning, resampling, normalization, feature extraction, and denoising.
Step 5: Guided by the global model, global control parameters, and local control parameters, each FDL client trains and updates its local load prediction model through multiple epochs of training, validation, and testing.
Step 6: The well-trained model can be used to predict future edge loads, which will help conduct rational and upfront resource provisioning for edge systems.
Step 7: After all selected FDL clients complete their local training and upload their local models and control parameters, the parameter server will make aggregation.
Step 8: The parameter server updates the global model and control parameters and then starts the next round of FDL cooperative training.

Classic FL (e.g., FedAvg) expects a well-performed global model, and thus there is commonly a specialized testing set for evaluating the global model. However, this manner may not be appropriate to all application scenarios of FL. Different from the existing studies, we expect that clients (i.e., edge servers) will be able to learn well-performed and personalized prediction models for diverse load variations in their own edge environments.

Therefore, we focus more on whether the MC-2PF can effectively support clients in improving the prediction performance of their local models. With this consideration, we extract testing sets for each client from local historical load data, aiming to conduct more targeted performance tests for the load prediction model of each client. Therefore, the objective function of the MC-2PF is defined as

$${min}_{w ∈ {ℝ}^{d}} {F}_{MC - 2 PF} = {\sum }_{k = 1}^{K} \frac{{n}_{k}}{n} {ℓ}_{k} ( {w}_{k} ) , \qquad ( 3 )$$

where wₖ is the local model (i.e., RNN-based load prediction model) of the client k, which is different from the definition in classic FL (as shown in Eq. (2)).

For complex and diverse patterns of edge load variations, the goal of the proposed MC-2PF is to minimize the errors between the predicted and actual loads on each edge server, which will assist edge systems in improving the running efficiency and QoS. Specifically, we adopt the following metrics that are commonly used in time-series prediction problems to comprehensively evaluate the accuracy of the MC-2PF for load prediction.
The mean-squared error (MSE) is defined as

$$MSE = \frac{1}{L} {\sum }_{t = 1}^{L} {( {\tilde{y}}_{t} - {y}_{t} )}^{2} , \qquad ( 4 )$$

where L is the prediction length, and yₜ and y̅ₜ are the actual and predicted values of loads at t, respectively.
The mean-absolute error (MAE) is defined as

$$MAE = \frac{1}{L} {\sum }_{t = 1}^{L} \vert {\tilde{y}}_{t} - {y}_{t} \vert . \qquad ( 5 )$$

The R-squared is defined as

$${R}^{2} = 1 - \frac{{\sum }_{t = 1}^{L} {( {y}_{t} - {\tilde{y}}_{t} )}^{2}}{{\sum }_{t = 1}^{L} {( {y}_{t} - \overline{y} )}^{2}} , \qquad ( 6 )$$

$$where \overline{y} = \frac{1}{L} {\sum }_{t = 1}^{L} {y}_{t} ,$$

and the values of R² are within the range [−∞,1]. The model owns better fitting performance when R² is closer to 1.

### Detailed Design of MC-2PF

Algorithm 1 shows the key steps of the proposed MC-2PF. First, the parameter server initializes the global model w, global control parameters c, and number of clients K (Line 2). Each FDL client maintains its local control parameters cₖ, and both c and cₖ are initialized by 0, where

$$c = \frac{1}{K} {\sum }_{k = 1}^{K} {c}_{k}$$

should be guaranteed. For each FDL communication round, according to the selection ratio C, the parameter server randomly selects max (C·K, 1) FDL clients from all K FDL clients to participate in the federated aggregation, and the FDL client set S is built (Lines 4˜5), where the function max (,) is used to avoid training interruptions if no FDL client is selected. Next, the parameter server distributes the global model w and global control parameters c to each FDL client in S (Line 6).

For each FDL client k (k∈S), it will receive the global model and global control parameters (w, c) and update its local model and local control parameters (wₖ, cₖ) (Line 8). Specifically, each FDL client conducts model training by utilizing local load data (Line 15), which contains the runtime information of resource usage (e.g., CPU, memory, disk usage, and I/O) on edge servers. If all these runtime information are used as training data, it will seriously increase the redundancy and complexity of the training process. To relieve this problem, we use CPU usage as the main prediction metric, which can best reflect the runtime performance of edge systems. For an edge server, xₜ indicates the CPU usage at t, and the time-series sequence of loads is denoted as X={x₁, x₂, . . . , xₙ}.

```
Algorithm 1: The proposed MC-2PF
  1 # Run the parameter server:
  2 Initialization: the global model w, global control
    parameters c, and number of clients K
  3 for each FDL round r = 1,2, . . . , R do
  4 | Generate the number of FDL clients:
    | m ← max (C·K, 1);
  5 | Build the FDL client set: S ← (select m clients);
  6 | Distribute the global model and global control
    | parameters (w, c) to the FDL client k, where
    | k ∈ S;
  7 | for each FDL client k do
  8 | Update the local model and local control
    | parameters: wₖ, cₖ ← ClientUpdate(k, w, c);
  9 |  $Update the global model : w ← {\sum }_{k = 1}^{K} \frac{{n}_{k}}{n} {w}_{k} ;$
10 | Update the global control parameters:
    |  $c ← {\sum }_{k = 1}^{K} \frac{{n}_{k}}{n} {c}_{k} ;$
11 | end
12 end
13 # Run ClientUpdate(k,w,c) on each FDL client k:
14 Initialization: the global model wₖ ← w, local control
    variate cₖ, number of clients K, learning rate η, and
    number of training epochs E
15 Input: raw load data X = {x₁, x₂, . . . , xₙ}
16 Obtain the preprocessed load data by normalization
    and SC-based denoising: X′ = (x′₁, x′₂, . . . , x′ₙ};
17 Build the local training data:
    B ← (split X′ into batches);
18 for epoch i = 1, 2, . . . , E do
19 | for batch b ∈ B do
20 | | Update the local model:
    | | wₖ ← wₖ − η (∇ [symbol]  (wₖ : b) − c_{w} + c);
21 | end
22 end
23 Update the local control parameters:
  ${c}_{k} ← {c}_{k} - c + \frac{1}{E η} ( w - {w}_{k} ) ;$
24 Return (wₖ, cₖ) to the parameter server;
```

Due to the high sampling frequency of raw load data, it is inevitably accompanied by massive noise. For the invalid load data, we replace it by taking the interval average during the preprocessing process and meanwhile compress it by resampling, which can extract the important features of raw load data. Moreover, there exist huge difference in the value range of raw loads for different periods, and thus we normalize raw loads (Line 16), aiming to speed up the convergence of local models. After normalization, the raw load data is mapped to the range [0,1], and this process is defined as

$$\tilde{X} = \frac{X - {X}_{min}}{{X}_{max} - {X}_{min}} , \qquad ( 7 )$$

where X indicates the raw load data. Xₘₐₓ and Xₘᵢₙ are the maximum and minimum CPU usage in the raw load data, respectively.

Meanwhile, to address the problem of high noise that seriously affects the prediction accuracy and causes high computational complexity, we design a Savitzky-Golay (SG) based filter to smooth the raw load data (Line 16), aiming to minimize the interference of noise (REFERENCES: Q. Dong, Y Lin, J. Bi, and H. Yuan, “An integrated deep neural network approach for large-scale water quality time series prediction,” in IEEE International Conference on Systems, Man and Cybernetics (SMC), pp. 3537-3542, IEEE, 2019.). Specially, we define a sub-sequence of X̅ as

$${S}_{q} = \{ {\tilde{x}}_{q - w} , {\tilde{x}}_{q - w + 1} , … , {\tilde{x}}_{q} , … {\tilde{x}}_{q + w - 1} , {\tilde{x}}_{q + w} \} , \qquad ( 8 )$$

where S_{q}⊆\tilde{X}, q is the center point of S_{q}, w is half the window length, and the length of S_{q} is (2w+1).

Next, we perform fitting for each element in S_{q} by

$${x}_{q + k}^{′} = {\sum }_{i = 0}^{γ} {a}_{i} {\tilde{x}}_{q + k}^{i} , \qquad ( 9 )$$

where \tilde{x} and x′ are the elements before and after fitting, respectively; Moreover, a is the fitting parameter and γ is the polynomial number.

Therefore, we can realize the element fitting in the window by solving a system of γ-element linear equations; Specifically, we first build a system of γ-element linear equations by forming (2w+1) equations from the elements in S_{q}; Next, the least square method is used to determine the fitting parameter a. The proposed SG-based filter will work in a sliding-window way until all load data is preprocessed.

Next, we split the preprocessed load data X′ into batches to serve as local training data for FDL clients (Line 17). Each FDL client performs E epochs for training its local model (Lines 18˜22), and the process of the local model update is defined as

$${w}_{k} ← {w}_{k} - η ( ∇ {ℓ}_{k} ( {w}_{k} : b ) - {c}_{w} + c ) , \qquad ( 10 )$$

where we introduce the difference term (c_{w}−c) to estimate the client-drift degree and use this term to correct the update direction of local models in time.

After completing local training, the local control parameters are updated (Line 23), and this process is defined as

$${c}_{k} ← {c}_{k} - c + \frac{1}{E η} ( w - {w}_{k} ) , \qquad ( 11 )$$

where η is the learning rate. The update of local control parameters cₖ considers the global control parameters c and the difference between the global model and the updated local model, denoted by (w−wₖ).

Finally, the FDL client k uploads the updated wₖ and cₖ to the parameter server (Line 24). After receiving the updated parameters of all participated clients, the parameter server updates the global model w and global control parameters c (Line 9˜10) and then starts the next round of FDL training. The update process is defined as

$$w ← {\sum }_{k = 1}^{K} \frac{{n}_{k}}{n} {w}_{k} , \qquad ( 12 )$$

$$c ← {\sum }_{k = 1}^{K} \frac{{n}_{k}}{n} {c}_{k} . \qquad ( 13 )$$

### Convergence Improvement by Control Parameters

To better demonstrate the positive impact of the designed control parameters c and cₖ on improving the performance of edge load prediction, we first offer a brief explanation of the client-drift issue that exists in classic FL, and then we theoretically analyze how the designed control parameters can effectively solve this issue.

FIG. 2 illustrates the convergence fluctuations of the load prediction models on two clients, including the updating direction of both local and global models and the convergence points of clients' models.

Due to huge differences in data distribution between the two clients, the convergence points of the clients' models exhibit obvious distinctions. In this case, the updating directions of clients might be biased with the influence of other clients, which is called the client-drift issue. This issue causes great difficulty to the FL training and also seriously degrades the model performance and generalization ability.

In classic FedAvg, each client receives the global model and updates its local model. This process is defined as

$${w}_{k} ← {w}_{k} - η ∇ {ℓ}_{k} ( {w}_{k} : b ) . \qquad ( 14 )$$

When the data of all clients are identically and independently distributed, the above update process is unbiased, and thus the update of each client can move in the direction of its convergence point. However, when there exist huge distinctions in data distribution among clients, the convergence points of clients might be greatly different. When facing this issue, the classic FedAvg cannot guarantee that the updates of all clients will move toward their convergence points, which seriously degrades the accuracy and convergence speed of prediction models.

To address this important problem, we design new control parameters (i.e., c and cₖ) to estimate the convergence direction of global and local models. By using c, each client is able to obtain information about the update directions of global and other local models during its update process. Specifically, as shown in Eq. (10), we introduce the difference term (cₖ−c) during the update process of local models, which estimates the client-drift degree and timely correct the update directions of local models. With this design, the shifts of local updates can be gradually corrected back to the ideal convergence direction, which leads to better prediction performance for the local models of different clients. After clients complete the update of their local models, according to Eqs. (11) and (13), both the local and global control parameters will be updated. The update of cₖ estimates the convergence directions of local models, and the update of c estimates the convergence direction of the global model, which also contains information about the update directions of all local models.

### Application of MC-2PF for RNN-Based Load Prediction Models

To verify the practicality and universality of the proposed MC-2PF, we use a specific example to show its application to the training process of an RNN-based load prediction model (i.e., LSTM). It is worth noting that the MC-2PF can also be applied to other RNN-based load prediction models such as GRU, BiLSTM, and Seq2Seq (S2S).

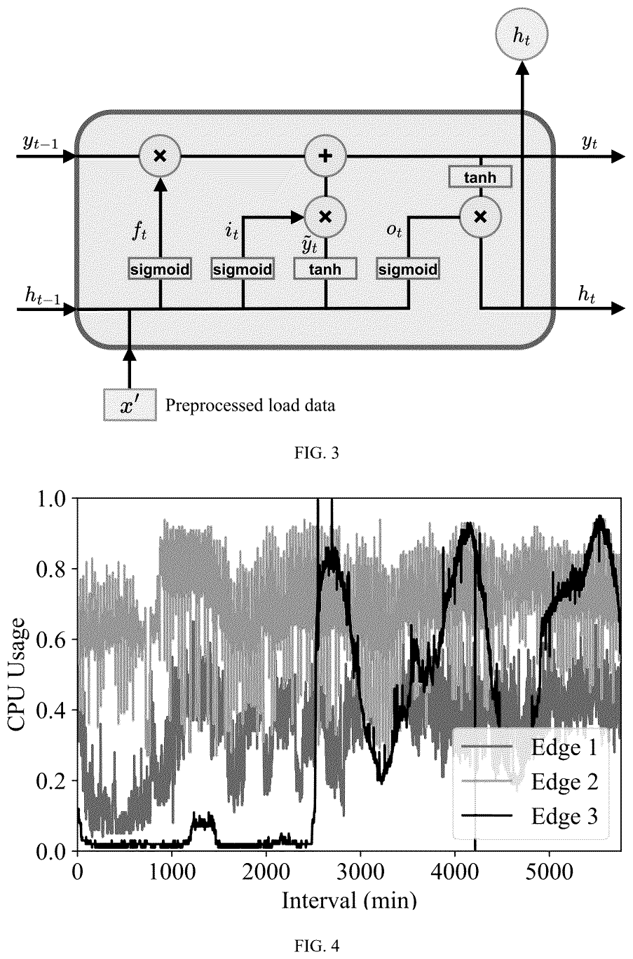

As an improved variant of RNN, LSTM shows a better ability to judge information than the classic RNN. Specifically, LSTM is able to selectively forget or retain information, solving the problem of vanishing or exploding gradients that exist in RNN when dealing with long-sequence prediction. As shown in FIG. 3, the LSTM cell utilizes three gates, including the input gate iₜ, forget gate fₜ, and output gate oₜ, to control the incoming information flow. \tilde{y}ₜ and yₜ indicate the current and previous moments of the cell status, respectively. fₜ decides the information that will be discarded from \tilde{y}ₜ, iₜ determines the new information that will be stored into yₜ, and oₜ calculates the output of hidden layers hₜ at t. The above components are defined as

$${y}_{t} = {f}_{t} {y}_{t - 1} + {i}_{t} {\tilde{y}}_{t} , \qquad ( 15 )$$

$${\tilde{y}}_{t} = tanh ( {W}_{y} [ {x}_{t} , {h}_{t - 1} ] + {b}_{y} ) , \qquad ( 16 )$$

$${f}_{t} = sig ( {W}_{f} [ {x}_{t} , {h}_{t - 1} ] + {b}_{f} ) , \qquad ( 17 )$$

$${i}_{t} = sig ( {W}_{i} [ {x}_{t} , {h}_{t - 1} ] + {b}_{i} ) , \qquad ( 18 )$$

$${o}_{t} = sig ( {W}_{o} [ {x}_{t} , {h}_{t - 1} ] + {b}_{o} ) , \qquad ( 19 )$$

$${h}_{t} = {o}_{t} tanh ( {y}_{t} ) , \qquad ( 20 )$$

where the trainable parameters are defined as the sets w={W_{y}, W_{f}, Wᵢ, Wₒ} and b={b_{y}, b_{f}, bᵢ, bₒ}. For the parameter server and each client in the MC-2PF, we design a set of control parameters with the same network structures as w and b, denoted by W_{c}={w_{y}′, w_{f}′, wᵢ′, wₒ′} and b_{c}={b_{y}′, b_{f}′, bᵢ′, bₒ′}, respectively.

Based on the above settings, the parameter server selects FDL clients to participate in federated aggregation, and the selected FDL clients are trained locally, as shown in Algorithm 1. Specifically, each FDL client employs stochastic gradient descent (SGD) to update w and b. During the training process of local models, the control parameters W_{c} and bₑ are used to correct the update directions of the learnable parameters. When an FDL client completes the update of its local model, it also updates its control parameters. After all FDL clients upload their local models and control parameters, the parameter server will perform the federated average for learnable and control parameters. Next, the MC-2PF proceeds to the next communication round and keeps training until models converge. Meanwhile, the proposed MC-2PF can be applied to other RNN-based load prediction models (e.g., GRU, BiLSTM, and S2S), and we comprehensively demonstrate the practicality and universality of the MC-2PF through extensive experiments in the next section.

### Performance Evaluation

In this section, we first presents the real-world experiment setup. Next, we evaluate the proposed MC-2PF through extensive experiments.

### 1. Experiment Setup

### 1.1 Real-World Testbed

We built a real-world testbed to simulate a scenario of multiedge cooperation for load prediction based on hardware devices. The testbed consists of a workstation and several Jetson TX2s. The workstation acts as the cloud datacenter (i.e., the parameter server), which is equipped with two NVIDIA GeForce GTX 3090 GPUs, an Intel® Xeon® CPU Silver 4208 @2.1 GHz, and a memory size of 32 GB. The Jetson TX2s act as edge servers (i.e., FDL clients), each of which is equipped with a NVIDIA Pascal GPU with 256 CUDA cores and a CPU cluster consisting of 2-core Denver2 and 4-core ARM CortexA57. We adopt the Ubuntu 18.04 operating system with CUDA v100 and cuDNN v7.5.0. Moreover, the workstation and Jetson TX2s are located within the same LAN, where the end-to-end communications between the workstation and Jetson TX2s are established based on the FLASK framework.

### 1.2 Datasets and Preprocessing

We adopt the real-world datasets of edge loads (M. Xu, Z. Fu, X. Ma, L. Zhang, Y Li, F. Qian, S. Wang, K. Li, J. Yang, and X. Liu, “From cloud to edge: a first look at public edge platforms,” in Proceedings of the 21st ACM Internet Measurement Conference, pp. 37-53, 2021.), which record the load variations of 6870 edge servers over 1 month with a sampling frequency of 1 minute. Specifically, we use CPU usage as the prediction metric, and we extract key information including the site IDs of edge servers, start recording time, end recording time, and sampling frequency. FIG. 4 illustrates the changes in CPU usage of different edge servers over various time intervals, and there exist huge distinctions in the load variation patterns of different edge servers. For example, the load variation of Edge 1 shows high periodicity, while the load variations of Edge 1 and 2 exhibit high randomness.

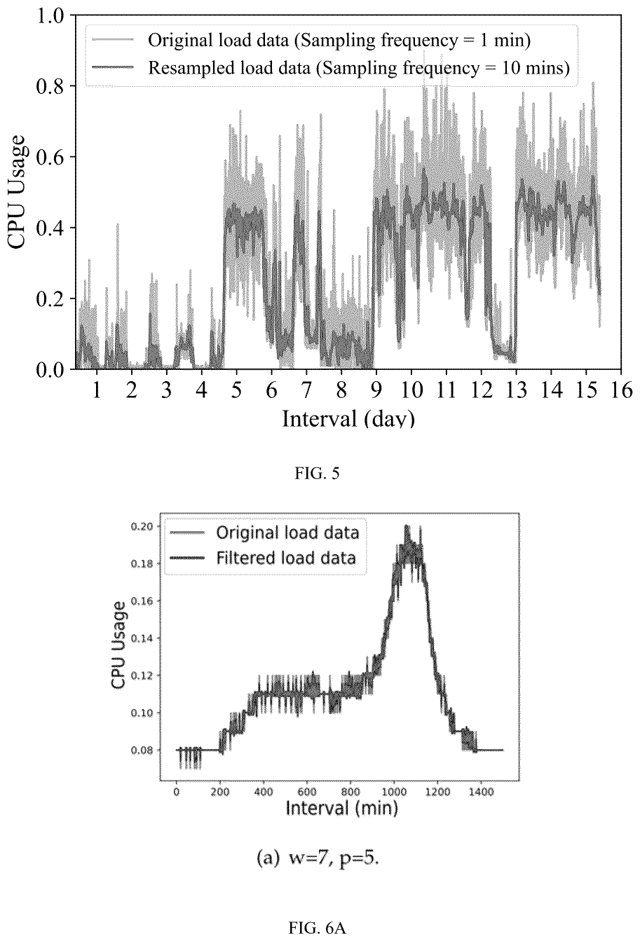

The datasets are divided into the training set (50%), validation set (25%), and testing set (25%). The training set is used for model training (i.e., calculate the weights of neural networks), the validation set is used for determining model parameters (i.e., select hyper-parameters and preventing overfitting), and the testing set is used for evaluating model performance. Meanwhile, multiple load instances are generated based on the load input and prediction lengths, and we set up three different scenarios with prediction lengths of minutes, hours, and days. For the minute-level, hour-level, and day-level prediction scenarios, the input and prediction lengths are set to 10 minutes, 1 hour, and 1 day, respectively. Moreover, we randomly choose a site ID as the basis for dividing the areas of cooperative training, which contains five edge servers. The edge servers (i.e., FDL clients) within the same site own independent historical load data, while the cloud data center (i.e., the parameter servers) do not contain load data. To eliminate the noise in load data and improve the accuracy and efficiency of load prediction, we set different resampling frequencies according to prediction lengths. For the minute-level and hour-level prediction scenarios, no resampling is performed because the original sampling frequency is also 1 minute. For the day-level prediction scenario, the resampling frequency is set to 10 minutes, and the upper-bound timestamps of intervals are taken as the new timestamps after resampling. As shown in FIG. 5, the resampled load data can retain the main features and variation patterns of the original load data. Meanwhile, the resampling can compress the original load data and eliminate the noise to a certain extent, reducing the complexity of model training and improving its convergence.

### 1.3 Benchmarks

To verify the superiority of the proposed MC-2PF, we compare it with the following two benchmark frameworks on different RNN-based load prediction models.
Local: Each edge server independently train its load prediction model without multi-edge cooperation.
FedAvg: Multiple edge servers cooperatively train their load prediction models based on the FedAvg.

The following five RNN-based load prediction models are considered on each edge server.
LSTM: As an improved RNN, the LSTM captures and processes long-term dependencies by introducing gate structures and memory units.
GRU: Compared to the LSTM, the GRU simplifies the gate structures and aims to handle long-term dependencies more efficiently.
BiLSTM: Compared to the LSTM, the BiLSTM considers both forward and backward sequence information, which can capture the context and dependencies in time-series data more comprehensively.
S2S-LSTM: The S2S-LSTM integrates the gate structures of the LSTM with the sequence-generation capability of the S2S.
S2S-GRU: The S2S-GRU integrates the gate structures of the GRU with the sequence-generation capability of the S2S.

Based on Python 3.6.9 and PyTorch 1.8.0, we implement the MC-2PF, Local, FedAvg, and five RNN-based load prediction models. For the MC-2PF and FedAvg, the maximum communication round is 500, the local training epoch of each FDL client is 10, the batch size is 64, and the learning rate is 0.001. For five RNN-based load prediction models, we adopt similar network structures, which make them own equivalent model scales. Specifically, in the LSTM and GRU, we use 4 hidden layers and each layer contains 64 neurons. In the BiLSTM, we use 2 hidden layers and each layer contains 64 neurons because the amount of its parameters is twice that of the LSTM. In the S2S, we use 2 layers for the encoder and 2 layers for the decoder, where each layer contains 64 neurons.

### 2. Experiment Results and Analysis

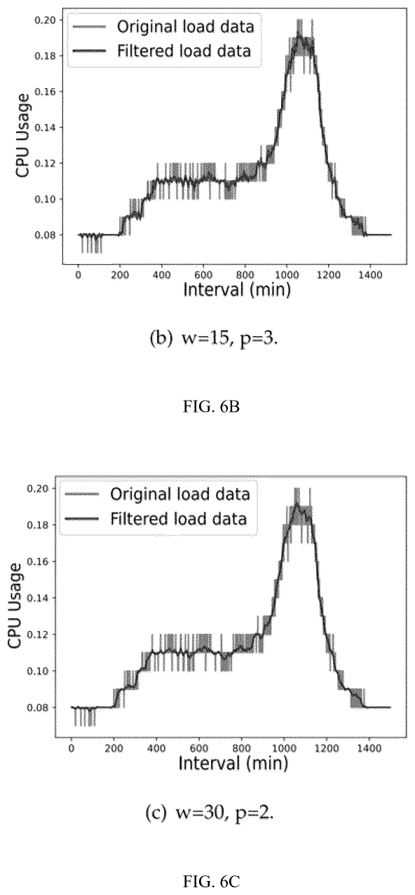

First, we analyze the impact of hyper-parameters on the performance of the SG-based filter. When preprocessing load data by using the SG-based filter, the window length (i.e., w) and the order of the fitting polynomial (i.e., p) should be set properly. The window length refers to the length of the sliding window that is used to fit the data, while the polynomial order refers to the order of the polynomial used in the sliding window. Specifically, FIG. 6A-C compares the load data before and after using the SG-based filter. As shown in FIG. 6A, when using a shorter window length (e.g., w=7) and a larger order of the fitting polynomial (e.g., p=5), the SG-based filter retains more detailed information of the original load data but cannot well smooth the data. In contrast, as shown in FIG. 6C, when using a longer window length (e.g., w=30) and a smaller order of the fitting polynomial (e.g., p=2), the SG-based filter can smooth the original load data better but may lose some meaning information about load variations.

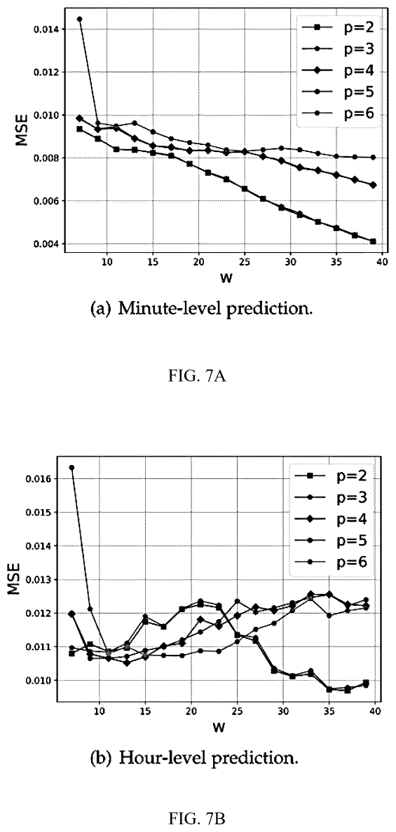

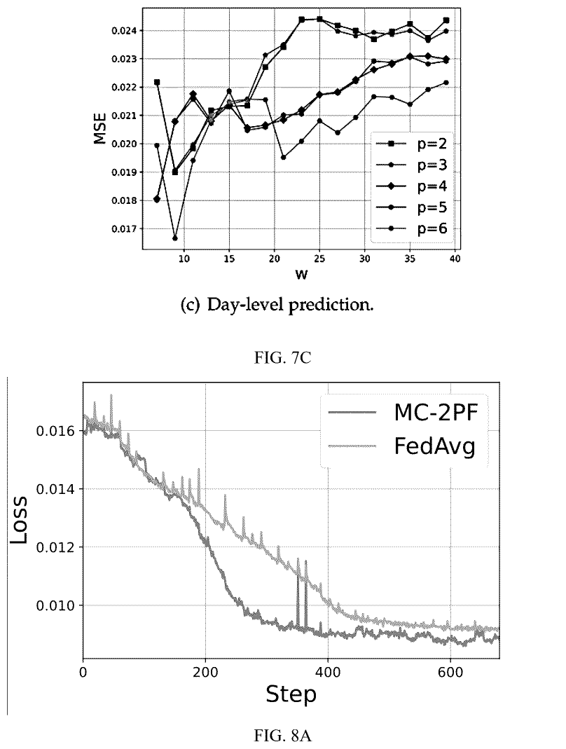

Furthermore, we integrate the datasets with the same site ID and test the prediction accuracy of the GRU-based model in terms of MSE under different scenarios by using the SG-based filter with various combinations of the window length (i.e., w) and the order of the fitting polynomial (i.e., p). As shown in FIG. 7A, the prediction accuracy rises as the values of w increase under the minute-level prediction scenario, where higher prediction accuracy occurs when smaller values of p are used. This is because the patterns of load variations in the minute-level prediction scenario are easy to be captured, and thus larger values of w and smaller values of p can assist in clarifying load changes, leading to better prediction results. Due to the constraints on the sequence length of the input network under the minute-level prediction scenario, we will use the largest-possible values of w and the smallest-possible values of w for such a prediction scenario. As shown in FIGS. 7B and 7C, with the increasing values of w, the prediction accuracy does not exhibit an obvious upward trend, and even downward trends happen in some cases. This indicates that too large values of w may cause negative effects on prediction accuracy under the hour-level and day-level prediction scenarios. Moreover, although the decreasing values of p can help reduce the computational complexity of model training, it also affects the prediction accuracy. This is because the patterns of load variations become more complex under the hour-level and day-level prediction scenarios. In this case, the lower values of p smooth the original load data but meanwhile some key load features might be lost. Based on extensive tests, we set the values of w and p as 29 and 3 for the hour-level prediction scenario, and we set the values of w and p as 21 and 6 for the day-level prediction scenario.

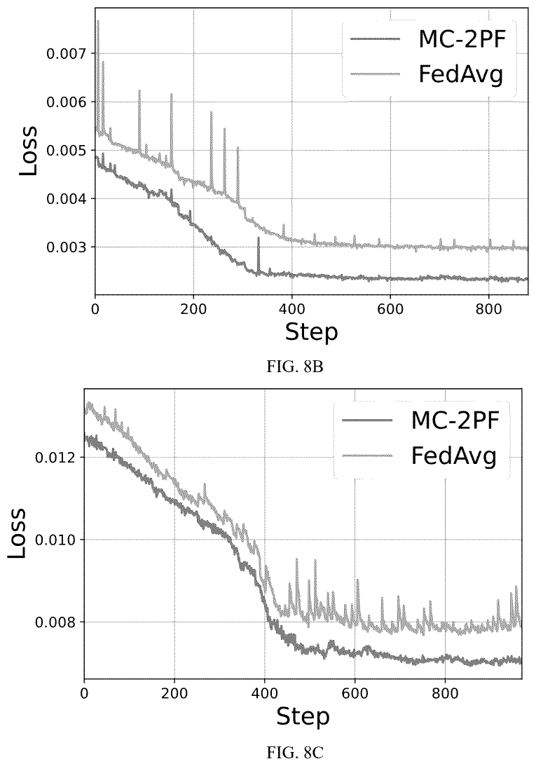

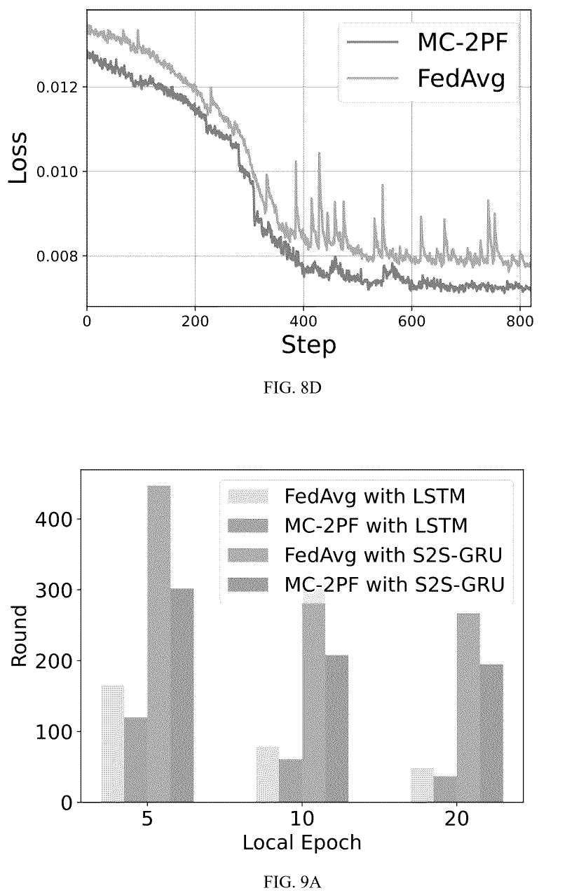

FIG. 8A-C illustrates the convergence of load prediction models trained with the proposed MC-2PF and classic FedAvg on different edge servers, where the MC-2PF can always converge to lower loss with faster speed than the FedAvg. Specifically, as shown in FIG. 8A, the convergence advantage of the MC-2PF is most obvious between 100 to 300 rounds compared to the FedAvg. This is because the proposed control parameters can correct the update direction of the model back to the ideal direction near the convergence point, and thus the MC-2PF is able to find the optimal solution faster than the FedAvg.

As shown in FIGS. 8B, 8C, and 8D, the loss curve occurs with high frequencies of abnormal fluctuations when using the FedAvg. This is because there exist huge differences in the data distribution among edge servers, and thus the decreasing model performance may happen after the federated aggregation. In this case, edge servers need to conduct local training and tuning over multiple steps for recovering to the pre-aggregation performance. Through introducing control parameters, the proposed MC-2PF timely corrects the convergence direction of the model and greatly reduces the large fluctuations that occur during model training, which makes the global model obtained after federated aggregation better adapt to various edge environments, and thus the convergence can be achieved more stably and quickly.

For diverse scenarios with various prediction lengths (i.e., minute-level, hour-level, and day-level prediction scenarios), we evaluate the accuracy of five RNN-based load prediction models (i.e., LSTM, GRU, BiLSTM, S2S-LSTM, and S2S-GRU) in terms of different metrics (i.e., MSE, MAE, and R²) under different training frameworks (i.e., Local, FedAvg, and the proposed MC-2PF). As shown in Table 1, the accuracy decreases as the increase of prediction lengths from the perspectives of all metrics. Specifically, when using the Local training framework, the values of R² are always negative for different prediction scenarios, reflecting the inferior fitting ability. This is because it is hard to obtain good model fitness through independently training prediction models on a single edge server without multi-edge cooperation.

TABLE 1
Prediction accuracy of different training frameworks with diverse
RNN-based models under various prediction scenarios.

| Training | Prediction | Min-Level Prediction | | | Hour-Level Prediction | | | Day-Level Prediction | | |
|---|---|---|---|---|---|---|---|---|---|---|
| Framework | Method | MSE | MAE | R² | MSE | MAE | R² | MSE | MAE | R² |
| | LSTM | 0.03912 | 0.15435 | <−100 | 0.03870 | 0.14743 | <−100 | 0.03609 | 0.13800 | <−100 |
| | GRU | 0.01264 | 0.08077 | −67.611 | 0.02664 | 0.11732 | <−100 | 0.03483 | 0.13668 | <−100 |
| Local | BiLSTM | 0.04224 | 0.16050 | −18.503 | 0.04349 | 0.15727 | <−100 | 0.05712 | 0.17487 | <−100 |
| | S2S-LSTM | 0.00957 | 0.06609 | <−100 | 0.03719 | 0.14700 | <−100 | 0.03785 | 0.15025 | <−100 |
| | S2S-GRU | 0.01265 | 0.08260 | −12.081 | 0.02294 | 0.10430 | −24.731 | 0.03272 | 0.13111 | <−100 |
| | LSTM | 0.00519 | 0.05208 | 0.69409 | 0.01494 | 0.08565 | 0.33268 | 0.02022 | 0.11790 | −11.53228 |
| | GRU | 0.00531 | 0.05686 | 0.62014 | 0.01507 | 0.08878 | 0.31589 | 0.02128 | 0.12749 | −23.40855 |
| FedAvg | BiLSTM | 0.00714 | 0.06968 | 0.49403 | 0.01889 | 0.10674 | 0.20387 | 0.03372 | 0.14113 | −57.01825 |
| | S2S-LSTM | 0.00458 | 0.05004 | 0.75063 | 0.01211 | 0.07952 | 0.53354 | 0.01846 | 0.12539 | −9.04374 |
| | S2S-GRU | 0.00478 | 0.05027 | 0.72509 | 0.01307 | 0.08315 | 0.48353 | 0.02068 | 0.12719 | −10.45095 |
| | LSTM | 0.00438 | 0.04366 | 0.78154 | 0.01139 | 0.07535 | 0.46373 | 0.01612 | 0.10179 | −0.40485 |
| | GRU | 0.00455 | 0.04878 | 0.72061 | 0.01192 | 0.07478 | 0.42749 | 0.01728 | 0.11749 | −0.53122 |
| MC-2PF | BiLSTM | 0.00537 | 0.05342 | 0.59932 | 0.01446 | 0.08490 | 0.28366 | 0.01955 | 0.13839 | −13.01582 |
| | S2S-LSTM | 0.00418 | 0.04274 | 0.79386 | 0.01022 | 0.06148 | 0.56290 | 0.01446 | 0.08476 | 0.21167 |
| | S2S-GRU | 0.00410 | 0.04181 | 0.80859 | 0.01089 | 0.06188 | 0.54605 | 0.01577 | 0.09141 | 0.14509 |

Compared to the Local, the model accuracy obtained by using the FedAvg training framework exhibits an obvious improvement. This is because the FedAvg not only uses local load data for model training but also draws on the experience of other edge servers to a certain extent, and thus it can achieve good prediction performance when facing highly-variable loads. However, the huge difference in data distribution among edge servers severely limits the generalization ability of the FedAvg, which may require more training data and time to achieve higher prediction accuracy for each model on edge servers. Compared to the FedAvg, the proposed MC-2PF training framework averagely improves the prediction accuracy by around 16˜8 for various RNN-based load prediction models when facing diverse prediction scenarios. This is because the MC-2PF is able to correct and optimize the model update direction by using the designed control parameters, which allows the experience of load prediction on edge servers to be learned from each other. The above results demonstrate the practicality and universality of the proposed MC-2PF to be applied to RNN-based models for improving load prediction accuracy.

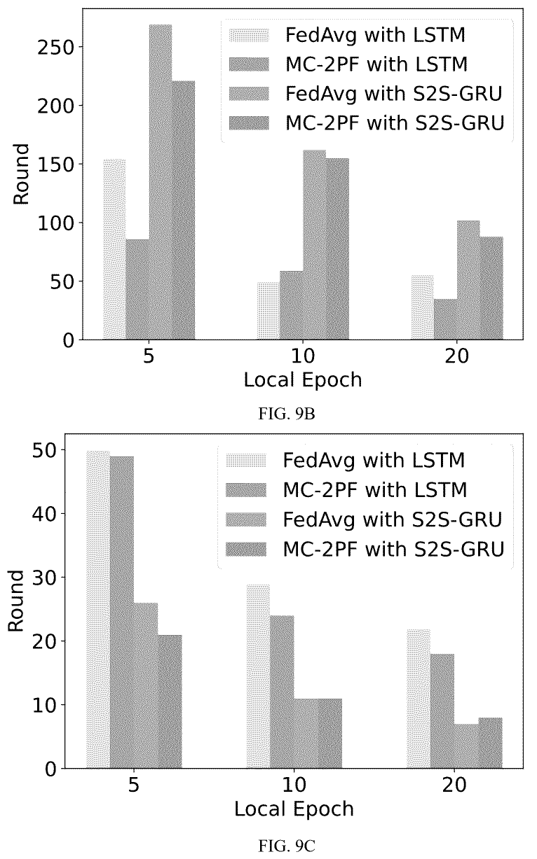

Next, we test the convergence speed of the LSTM and S2S-GRU based load prediction models when using the proposed MC-2PF and FedAvg training frameworks, where the target convergence accuracy is set to 0.005, 0.015, and 0.020 in terms of MSE for the minute-level, hour-level, and day-level prediction scenarios, respectively. FIG. 9A-C compares the communication rounds to achieve convergence by using different load prediction models under various training frameworks. For different settings of local training epochs (i.e., 5, 10, and 20), the MC-2PF can spend fewer communication rounds to achieve the target convergence accuracy in most of prediction scenarios compared to the classic FedAvg. Specifically, in the minute-level prediction scenario, the communication rounds for convergence are much less than the hour-level and day-level prediction scenarios because the patterns of load variations are easy to be captured with a short prediction length. As the prediction length increases, the load fluctuations become more complex and variable, thus it requires more communication rounds to achieve the target convergence accuracy. When dealing with the hour-level and day-level prediction scenarios with more complex load variations, the MC-2PF can still reduce communication rounds by 15˜25% than the FedAvg.

This is because the MC-2PF utilizes control parameters to conduct effective correction during the model update, which significantly improves the efficiency of multi-edge cooperative training.

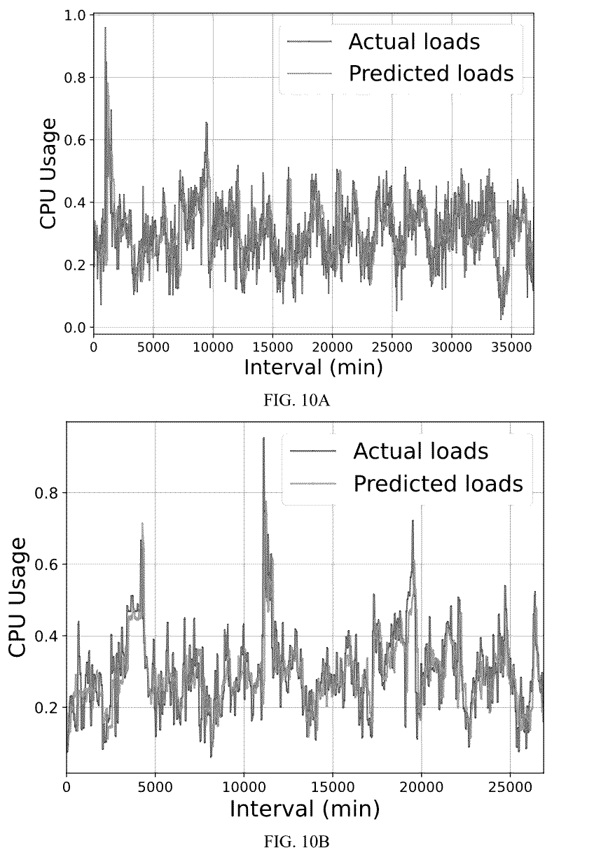

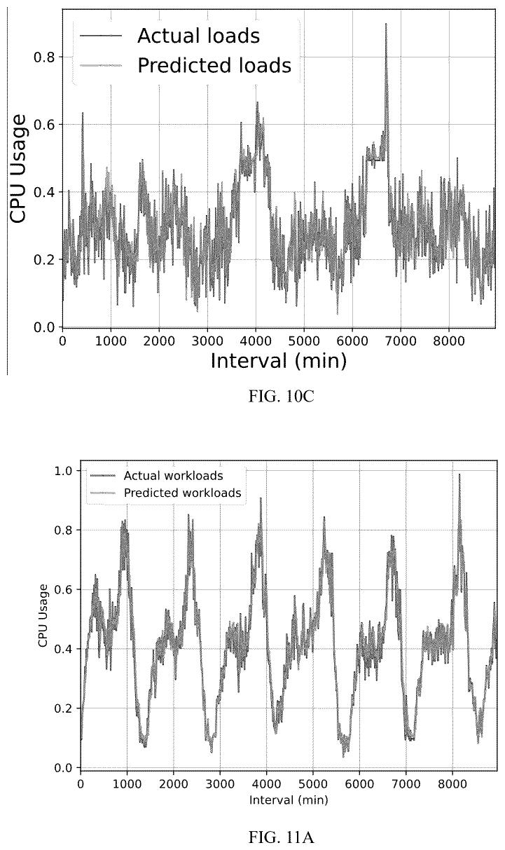

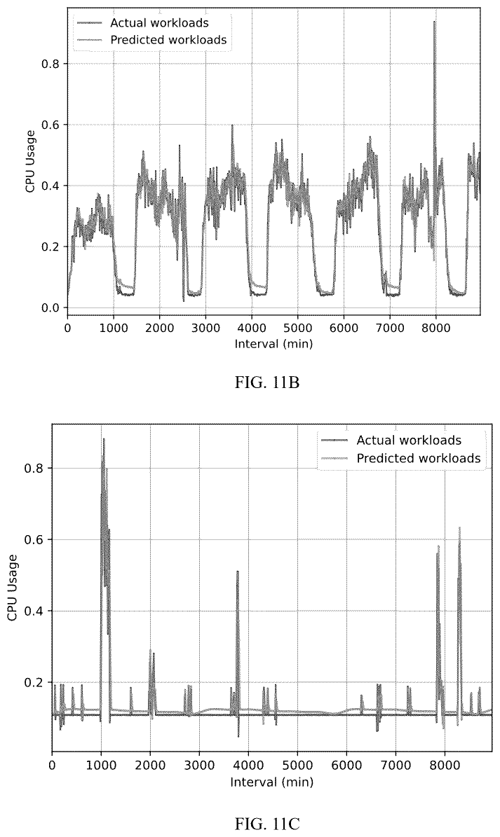

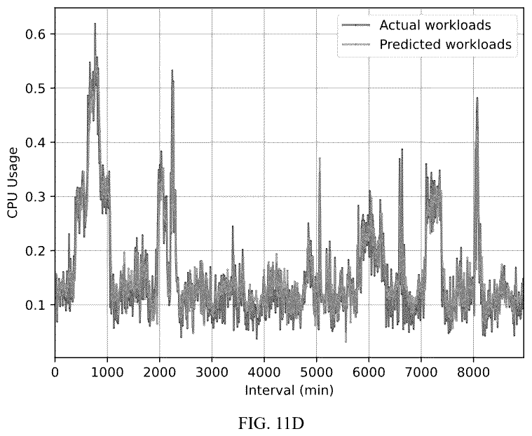

Finally, we exhibit the performance of the S2S-GRU-based prediction model with the proposed MC-2PF training framework under different prediction scenarios (i.e., minute-level, hour-level, and day-level) and multiple load types (i.e., highly-periodic and highly-random). As shown in FIG. 10A-C, the trained model can always achieve accurate prediction under different prediction scenarios, with the best performance under the minute-level prediction scenario. With the increase in prediction lengths and difficulty, there occurs a slight degradation in prediction accuracy, but the fluctuating trend of loads can still be well captured with the support of the proposed MC-2PF training framework. Moreover, FIG. 11A-D illustrates the prediction effect for different types of loads under the minute-level prediction scenario, where the trained model can keep high prediction accuracy when facing both highly-periodic and highly-random loads. Specifically, when facing highly-periodic loads, the trained model can predict load variations very accurately. For example, when occurring a sudden load peak such as the load at 8000 mins in FIG. 11B, the trained model can still precisely capture and predict this change. Meanwhile, as shown in FIGS. 11C and 11D, when facing different types of highly-random loads, the trained model can still maintain high prediction accuracy. This is because the proposed MC-2PF effectively improves the model generalization ability, enabling high adaptiveness for different patterns of load variations.

### CONCLUSIONS

We propose the MC-2PF, a novel Multi-edge Cooperative universal framework for load Prediction with Personalized FDL. The MC-2PF adaptively achieves accurate and efficient load prediction by effectively addressing the key challenges including high variability and noise of loads, insufficient historical load data, and limited generalization ability of models. Specifically, we design an SG-based filter to smooth raw load data, which reduces noise interference and mitigates model over-fitting. In particular, we design novel model control parameters to correct directions of model update and solve the client-drift issue in classic FL caused by highly-distinct data distribution, and theoretically analyze the convergence improvement by using this design. Using the real-world testbed and datasets of edge loads, extensive experiments validate the effectiveness and universality of the proposed MC-2PF. The results show that the MC-2PF can be applied to train advanced RNN-based load prediction models including LSTM, GRU, BiLSTM, S2S-LSTM, and S2S-GRU, and achieves excellent performance from the perspectives of prediction accuracy and convergence speed. Moreover, the SG-based filter can support improving prediction accuracy and reducing training complexity. Notably, the MC-2PF owns stronger adaptiveness and achieves higher prediction accuracy than the singleedge training framework on different RNN-based models. Compared to the benchmark FedAvg training framework, the MC-2PF is still able to further improve accuracy by around 16˜28% and enhance convergence speed by around 15˜25% under different prediction scenarios.

The above are preferred embodiments of the present invention, and any change made in accordance with the technical solution of the present invention shall fall within the protection scope of the present invention if its function and role do not exceed the scope of the technical solution of the present invention.

What is claimed is:

1. A multi-edge cooperative universal framework for load prediction with personalized federated deep learning, comprising:
adopting an FDL-based cooperative training manner in multi-edge environments, using site IDs of edge servers as the basis for dividing the regions of cooperative training; and
the edge servers within a same site are regarded as clients in FDL, and the edge servers conduct cooperative training with a parameter server in FDL.

2. The multi-edge cooperative universal framework for load prediction with personalized federated deep learning according to claim 1, the FDL cooperative training further comprises the following steps:
Step 1: the parameter server selects FDL clients to participate in a current round of federated aggregation;
Step 2: the selected FDL clients participate in the current round of federated aggregation;
Step 3: the FDL clients receive a global model and control parameters distributed by the parameter server, and then starts local training with historical loads;
Step 4: each FDL client preprocesses the historical load data stored on its edge server including cleaning, resampling, normalization, feature extraction, and denoising;
Step 5: guided by the global model, global control parameters, and local control parameters, each FDL client trains and updates its local load prediction model through multiple epochs of training, validation, and testing;
after all selected FDL clients complete their local training and upload their local models and control parameters, the parameter server will make aggregation; and
the parameter server updates the global model and control parameters and then starts a next round of FDL cooperative training.

3. The multi-edge cooperative universal framework for load prediction with personalized federated deep learning according to claim 2, wherein a well-trained model is used to predict future edge loads.

4. The multi-edge cooperative universal framework for load prediction with personalized federated deep learning according to claim 2, wherein:
the parameter server initializes the global model w, global control parameters c, and number of clients K;
each FDL client maintains its local control parameters cₖ, and both c and cₖ are initialized by 0, where
$$c = \frac{1}{K} {\sum }_{k = 1}^{K} {c}_{k}$$
should be guaranteed;
for each FDL communication round, according to the selection ratio C, the parameter server randomly selects max (C·K, 1) FDL clients from all K FDL clients to participate in the federated aggregation, and the FDL client set S is built, where the function max (,) is used to avoid training interruptions if no FDL client is selected;
the parameter server distributes the global model w and global control parameters c to each FDL client in S;
for each FDL client k (k∈S), it will receive the global model and global control parameters (w, c) and update its local model and local control parameters (wₖ, cₖ); and
each FDL client conducts model training by utilizing local load data, which contains runtime information of resource usage on the edge servers.

5. The multi-edge cooperative universal framework for load prediction with personalized federated deep learning according to claim 4, wherein:
CPU usage is used as the main prediction metric;
for an edge server, xₜ indicates the CPU usage at t, and a time-series sequence of loads is denoted as X={x₁, x₂, . . . , xₙ}.

6. The multi-edge cooperative universal framework for load prediction with personalized federated deep learning according to claim 5, wherein:
invalid load data is replaced by taking the interval average during the preprocessing process and meanwhile compress the invalid load data by resampling, which can extract important features of raw load data; and thus normalize raw loads, aiming to speed up the convergence of local models; after normalization, the raw load data is mapped to the range [0,1], and the preprocessing process is defined as
$$\tilde{X} = \frac{X - {X}_{min}}{{X}_{max} - {X}_{min}}$$
where X indicates the raw load data; Xₘₐₓ and Xₘᵢₙ are a maximum and a minimum CPU usage in the raw load data, respectively.

7. The multi-edge cooperative universal framework for load prediction with personalized federated deep learning according to claim 6, wherein:
a Savitzky-Golay (SG) based filter is used to smooth the raw load data, aiming to minimize the interference of noise; define a sub-sequence of X as
$${S}_{q} = \{ {\tilde{x}}_{q - w} , {\tilde{x}}_{q - w + 1} , … , {\tilde{x}}_{q} , … {\tilde{x}}_{q + w - 1} , {\tilde{x}}_{q + w} \}$$
where S_{q}⊆\tilde{X}, q is the center point of S_{q}, w is half the window length, and the length of S_{q} is (2w+1);
perform fitting for each element in S_{q} by
$${x}_{q + k}^{′} = {\sum }_{i = 0}^{γ} {a}_{i} {\tilde{x}}_{q + k}^{i}$$
where \tilde{x} and x′ are the elements before and after fitting, respectively;
moreover, a is a fitting parameter and γ is a polynomial number;
realize the element fitting in the window by solving a system of γ-element linear equations;
we first build a system of γ-element linear equations by forming (2w+1) equations from the elements in S_{q};
a least square method is used to determine the fitting parameter a; and
a proposed SG-based filter will work in a sliding-window way until all load data is preprocessed.

8. The multi-edge cooperative universal framework for load prediction with personalized federated deep learning according to claim 7, wherein:
the preprocessed load data X′ is split into batches to serve as local training data for FDL clients;
each FDL client performs E epochs for training its local model, and the process of the local model update is defined as
$${w}_{k} ← {w}_{k} - η ( ∇ {ℓ}_{k} ( {w}_{k} : b ) - {c}_{w} + c )$$
where the difference term (c_{w}−c) is used to estimate the client-drift degree and to correct the update direction of local models in time;
after completing local training, the local control parameters are updated and the updating process is defined as
$${c}_{k} ← {c}_{k} - c + \frac{1}{E η} ( w - {w}_{k} )$$
where η is the learning rate;
the update of local control parameters cₖ considers the global control parameters c and the difference between the global model and the updated local model, denoted by (w−wₖ); and
the FDL client k uploads the updated wₖ and cₖ to the parameter server; After receiving the updated parameters of all participated clients, the parameter server updates the global model w and global control parameters c and then starts the next round of FDL training; an update process is defined as
$$w ← {\sum }_{k = 1}^{K} \frac{{n}_{k}}{n} {w}_{k} ,$$
$$c ← {\sum }_{k = 1}^{K} \frac{{n}_{k}}{n} {c}_{k} .$$
